(19) United States
(12) Patent Application Publication
(10) Pub. No.: US 2002/0066631 A1
(43) Pub. Date: Jun. 6, 2002

(54) Torque converter clutch and multiple stage damper

(76) Inventors: Tomasz K. Kietlinski, Grosse Pointe, MI (US); Willem S. Haven, Waterford, MI (US)

Correspondence Address: Kenneth H MacLean, CIMS 483-02-19, DaimlerChrysler Intellectual Capital Corporation, 800 Chrysler Drive East, Auburn Hills, MI, 48326-2757, US

(21) Appl. No.: 09/728,345

(22) Filed: Dec. 1, 2000

(51) Int. Cl. F16H 45/02

(52) U.S. Cl. 192/3.29; 192/213

(57) ABSTRACT

A damper assembly for a friction clutch includes a first and second series of springs arranged by a first and second series of spring pockets disposed around the outer circumference of the clutch. Vertical flange sections are configured to influence the springs against perpendicular walls of the damper minimizing frictional input. An arm ring of a turbine assembly rotatably communicates with the first series of springs to displace them a predetermined distance. Subsequent rotation of the arm ring displaces the second series of springs along with continuous displacement of the first series of springs creating a multi-rate damper.

### FIELD OF THE INVENTION

The present invention relates generally to friction clutches, and more particularly to a friction clutch having a multi-rate damper.

### BACKGROUND

Friction clutches are disposed in a torque transmitting relationship between an internal combustion engine and a transmission as is well known. A spring damper assembly is used to limit the transmission of torsional disturbances between the engine and the transmission. Spring damper assemblies generally have a plurality of spring members which are disposed between the input and output members of the damper. Generally, the spring members are limited in their travel which controls the angular excursion permitted within the damper assembly.

Various types of damper assemblies are configured with caged spring members. During relative rotation of the input and output members of the damper assembly, the spring members compress and are influenced against the contoured walls of their respective cage. Such a relationship can introduce friction around the circumferential surface of the spring. It would be advantageous to provide a method of containment for the spring members while minimizing the amount of contact therebetween.

Conventional damper assemblies provide a series of spring members having equal length located around the damper. Such a configuration provides a linear rate damping characteristic. It would be desirable to provide a system of spring members arranged to provide multi-rate damping.

### SUMMARY OF THE INVENTION

It is a general object of the present invention to provide a friction clutch and damper assembly having a first and second series of dampers located around a circumferential edge of a piston assembly adapted for rotational engagement with a turbine assembly. The turbine assembly includes an arm ring having a series of arms configured to mechanically compress the first series of dampers a predetermined distance prior to engagement of the second series of dampers.

It is another object of the present invention to provide a friction clutch and damper assembly including a first and second series of pockets adapted to locate the first and second series of dampers alternately around the circumferential edge of the piston assembly. The pockets ends are configured to influence the springs away from the pocket walls and against the perpendicular walls of the piston plate and circumferential flange minimizing frictional contact.

It is a further object of the present invention to provide a friction clutch and damper assembly having a piston plate rotatably communicating with a friction wafer, the piston plate carbonitrited or nitrited to improve durability and consistent operation.

It is yet another object of the present invention to provide a friction clutch and damper assembly including a first series of pockets having an integrated stop section adapted to cooperate with the series of arms of the turbine assembly to limit compression of the first series of dampers to a predetermined distance.

It is still another object of the present invention to provide a friction clutch and damper assembly including a third series of dampers located around the circumference of the piston assembly located within a first series of pockets and adapted to be influenced by the arms of the turbine assembly after the first series of dampers have been partially displaced a predetermined distance.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a cross-sectional view of the friction clutch and damper according to the teachings of this invention;

FIG. 2 is a partial perspective view of the piston plate, damper assembly and arm ring according to the preferred embodiment;

FIG. 3 is a perspective view of the spring pocket plate removed from the damper assembly;

FIG. 4 is a perspective view of the rear side of the turbine assembly to illustrate the circumferential arm ring;

FIG. 5 is a perspective view of the piston plate and damper assembly according to a second embodiment;

FIG. 6 is a cutaway perspective view of the piston plate and damper assembly according to a third embodiment.

### DETAILED DESCRIPTION OF THE PREFERRED EMBODIMENTS

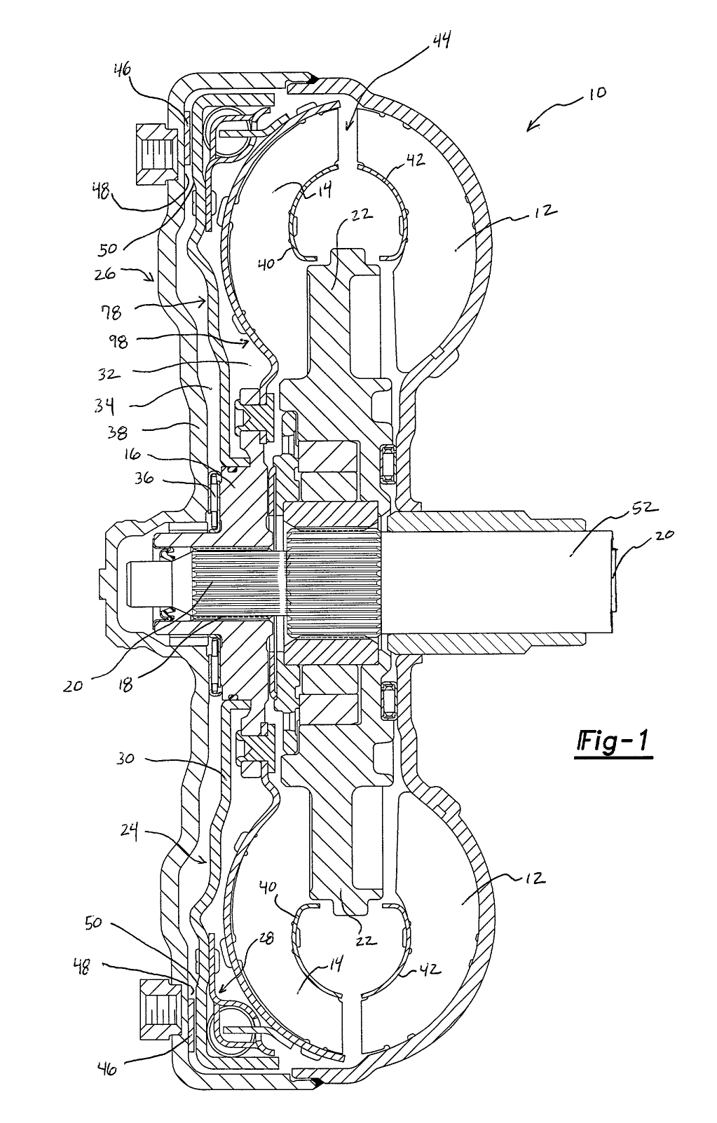

With general reference to FIGS. 1-5 a torque converter and damper assembly constructed in accordance with the teachings of the present invention will be described. With particular reference to FIG. 1, there is shown a torque converter and damper assembly 10 in accordance with the preferred embodiment of the present invention. As is well known, torque converters utilize the rotating elements in a fluid filled housing to multiply engine torque. All use the engine to drive the impeller 12 which, in turn, impels the fluid against the veins of the turbine 14. The turbine 14 includes an output hub 16 which is splined to a transmission input shaft 20 at 18. The transmission input shaft 20 provides an input for a multi-speed transmission. The torque converter 10 operates in a well known manner to provide drive from an engine, not shown, to a transmission of a vehicle, not shown. The torque converter 10 is a fluid drive and therefore accommodates the torsional disturbances which are produced at the engine due to the firing frequency of the pistons. The stator 22 communicates with the reaction shaft 52, and serves to redirect oil flow from the turbine 14 against the impeller veins 12 to boost impeller action and multiply engine torque.

To improve the operating efficiency of the torque converter 10, a torque converter clutch 24 is provided to establish a direct drive connection between the cover assembly 26 and the transmission input shaft 20. The torque converter clutch 24 can be fluid operated to provide a frictional engagement for transmitting torque from the engine to the transmission. Additionally, it is also well known in these types of torque transmitting connections; i.e., clutches, will transmit torsional disturbances which are found in the drive line at the engine interface.

A damper assembly 28 is provided to reduce the amount of torsional vibration transmitted to the input shaft 20. The damper assembly 28 is interconnected to the piston plate 30 which is interconnected to the turbine output hub 16. When the clutch 24 is engaged, a drive connection is provided through the piston plate 30 and the damper assembly 28 to the output hub 16.

Fluid chambers 32, 34 are formed on both sides of the piston plate 30. A thrust bearing 36 is axially located between the output hub 16 and the torque converter front cover 38. The support ring thrust bearing 36 allows oil flow between front cover 38 and turbine output hub 16.

In operation, the turbine wheel 40 is driven by the impeller wheel 42 from the circulation of fluid in the casting 44. To avoid slip between the impeller wheel 42 and turbine wheel 40 after startup, the torque converter clutch 24 connects front cover 38 with the output hub 16. This is achieved from the hydraulic pressure in fluid chamber 32 influencing the piston plate 30 against the friction material 46 radially disposed on the inner surface 48 of the cover assembly 26.

The outer surface, or friction face 50 of the piston plate 30 is carbonitrited or nitrited to improve wear characteristics thereof. This treatment allows for durable surface texture and microstructure, heat resistance and dimensional stability which are desirable qualities of a surface exposed to such frictional inputs. It is apparent, however, that the friction material 46 may be disposed radially around the outer surface of the piston plate 50. Likewise, the inner surface of the cover assembly 48 may be carbonitrided or nitrided according to such a configuration providing like results.

Turning now to FIG. 2, the damper assembly 28 will now be described in greater detail. The damper assembly 28 is interconnected to the piston plate 30. The damper assembly 28 includes a first and second series of spring pockets 70,72 circumferentially located around a spring retainer, or pocket plate 54 of the piston plate 30. The first series of spring pockets 70 are configured to retain a first series of springs 60 of a first length. The second series of spring pockets 72 are configured to retain a second series of springs 62 of a second length. The first series of springs 60 and spring pockets 70 are adapted to be a length greater than the second series of springs 62 and spring pockets 72.

The first and second series of springs 60,62 and spring pockets 70,72 are alternately disposed around the circumference of the piston plate 30. The piston plate 30 includes an outer circumferential wall 74 which extends substantially perpendicular therefrom. The placement of the springs 60,62 at the most outboard location allows for larger tolerances and eliminates the need of length-sorting the springs which is typical for designs placing springs close to the main axis of the damper assembly 28.

The first and second series of spring pockets 70,72 are configured such that the springs 60,62 realize a three point contact during rotation of the arm ring 76. To provide a smooth actuation of the piston assembly 78 and to protect spring ends from premature wear, the springs are fitted with end buttons 80. During compression, a given spring will be influenced at the end buttons 80 from the arms 90 of the arm ring 76 on one end and from the outer flange 92 of the pockets 70,72 on the other. A first and second side of a given spring will slidably communicate with the inner surface 94 of the piston plate 30 and the inner surface 96 of the circumferential wall 74. The curvature of the spring pockets 70,72 influence the springs 60,62 into the piston plate walls 94,96 and away from contact with the contoured radial wall of the spring pocket. Because the springs 60,62 are engaged only at the spring ends and by the first and second substantially perpendicular walls 94,96 of the piston plate 30, the frictional inputs of the springs 60,62 are minimized. The contoured wall of the spring pockets 70,72 are configured such that in case of spring failure due to unforeseen wire problems, the pocket will prevent migration of a loose spring wire.

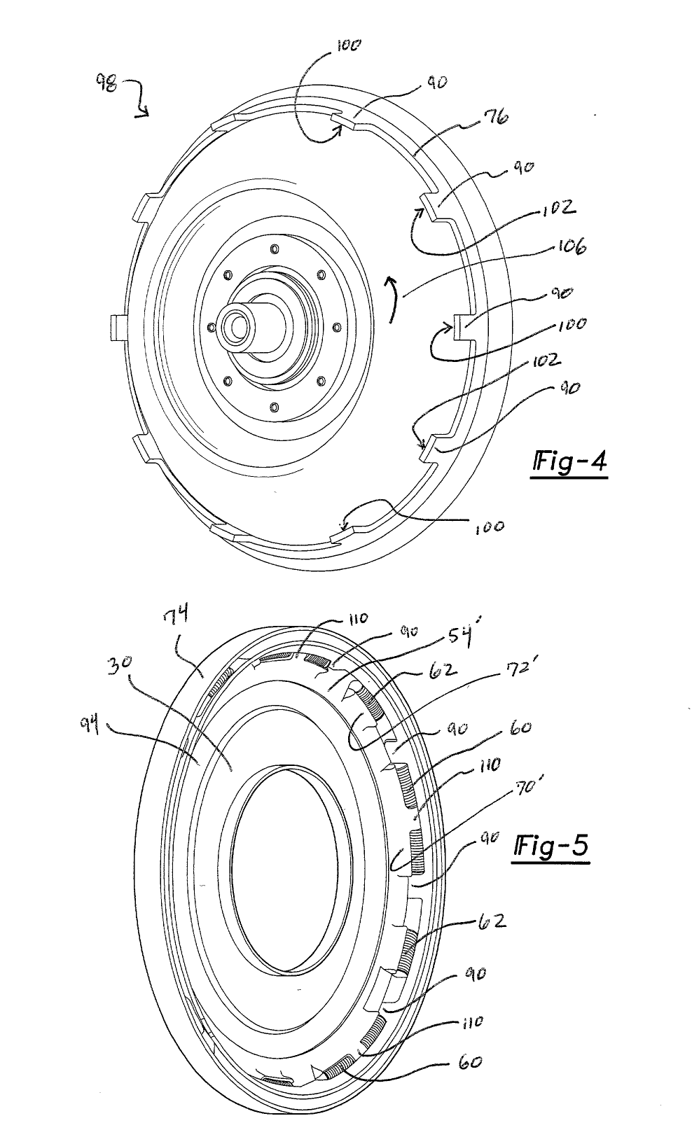

As is best shown in FIG. 4, the turbine assembly 98 includes an arm ring 76 disposed therearound. The arm ring 76 includes a series of arms 90 outwardly extending therefrom. The arms are operatively located a predetermined distance apart such that first and second consecutive arms mechanically communicate with springs 60 of the first series in an uncompressed static state. The predetermined distance the arms 90 are separated allows a first series of arms 100 to compress a first series of springs 60 a predetermined distance prior to the second series of arms 102 contacting the second series of springs 62. Explained further, the first series of arms 100 compress the first series of springs 60 as the turbine assembly 98 rotates in a counterclockwise direction 106. Once springs 60 have compressed a predetermined distance, arms 102 contact springs 62 of the second series. Subsequent counterclockwise rotation compresses the second series of springs 62 and continues further compression of springs 60 of the first series. This configuration provides a dual rate damping system.

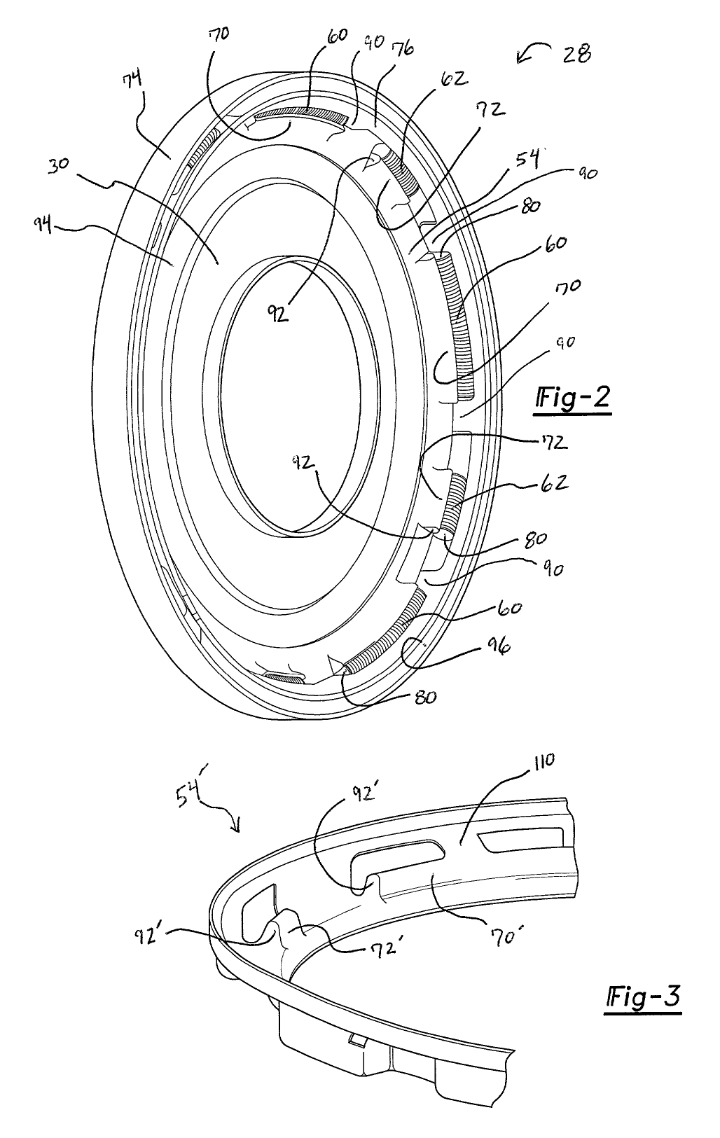

Referencing FIG. 3 and 5, a second embodiment of the present invention includes a pocket plate 54′. Pocket plate 54′ like pocket plate 54 is configured with flanges 92′ of pocket walls 70′ and 72′. Pocket plate 54′ includes strap sections 110 integrated on the first series of spring pockets 70′. The strap sections 110 are configured to resist spring compression to a predetermined distance. During operation, the arms 90 of the arm ring 76 rotate a predetermined distance until contacting the strap sections 110 of the spring pockets 70′. The strap sections 110 can limit the angle of relative rotation between the piston assembly 78, engaged at the friction face 50 with friction material 46 of the cover assembly 26, and the turbine assembly 98. The strap sections 110 are used to either limit the amount of damper travel and/or protect springs 60,62 from undesired loads. Straps 110, however, are not used to support the springs 60,62 or to provide a reaction surface for the springs 60,62.

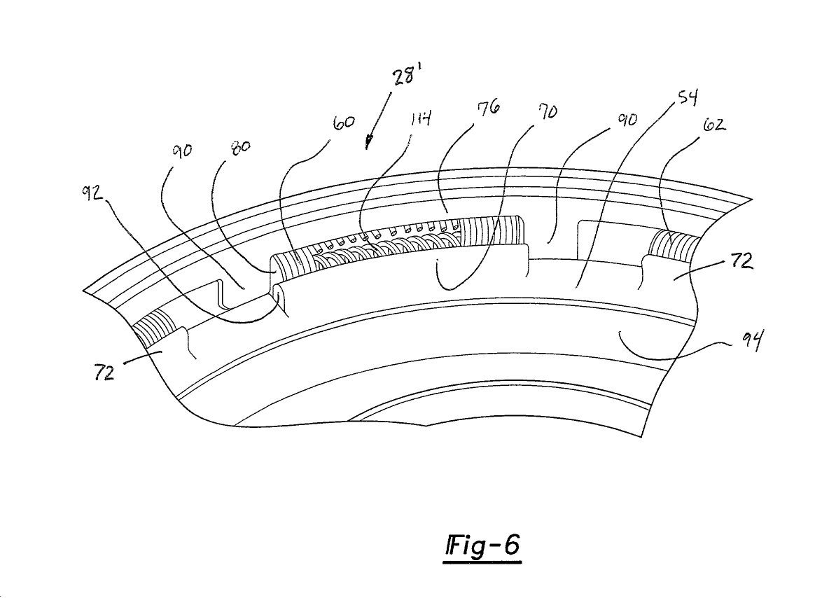

Turning now to FIG. 6, a damper assembly 28′ according to a third embodiment is shown. The first and second series of springs 60,62 and spring pockets 70,72 are alternately disposed around the circumference of the piston plate as in the first embodiment. The first spring pocket 70 retains the first series of springs 60 as well as an additional third series of springs 114. The third series of springs 114 are a predetermined distance shorter than the first series of springs 60. During operation, the first series of springs 60 are displaced a predetermined distance prior to the second set of springs 114 displacing a predetermined distance. Once the first and third set of springs displaces a predetermined distance the second series of springs 62 are compressed. This system allows for a three rate damping system. The third embodiment is shown without the straps 110 of the second embodiment, however the spring configuration of the third embodiment may include the stop sections described in the second embodiment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A friction clutch and damper comprising:
a piston assembly having an inboard surface, an outboard surface and an inwardly extending flange defining a circumferential wall;
a first series of dampers having a first length;
a second series of dampers having a second length, the first length greater than the second length;
a first and second series of pockets configured to locate a damper of the first series and a damper of the second series alternatively around the perimeter of the inboard surface of the piston assembly;
a turbine adapted for rotational engagement with the piston assembly having a series of outwardly extending tabs configured to mechanically communicate with the circumferential ends of the first series of dampers; wherein the tabs of the turbine displace the first series of dampers a predetermined distance prior to displacing the second series of dampers.

2. The friction clutch and damper according to claim 1, wherein the piston assembly further includes a cover plate adapted for rotatable engagement with the outboard surface of the piston.

3. The friction clutch and damper according to claim 2, wherein one of the outboard surface of the piston and the cover plate includes a friction material disposed thereon.

4. The friction clutch and damper according to claim 3, wherein the other of the outboard surface of the piston and the cover plate is heat treated

5. The friction clutch and damper according to claim 1, wherein the retaining pockets further include a stop configured to engage the tabs of the turbine thereby limiting rotation of the turbine to a predetermined distance.

6. The friction clutch and damper according to claim 1, wherein the second series of dampers further includes a third series of dampers disposed therein.

7. The friction clutch and damper according to claim 1, wherein the circumferential wall of the piston assembly is substantially perpendicular to the inboard surface of the piston assembly such that the first and second series of springs are configured for slidable engagement therewith.

8. A friction clutch and damper comprising:
a piston assembly having a circumferential flange;
a first and second series of dampers;
a first and second series of pockets adapted to locate the first and second series of dampers around the circumferential flange of the piston assembly;
a turbine assembly adapted for rotational engagement with the piston assembly, the turbine assembly having a series of arms configured to mechanically compress the first series of dampers a predetermined distance prior to engagement of the second series of dampers.

9. The friction clutch and damper according to claim 8, wherein the first series of dampers have a length greater than the second series of dampers.

10. The friction clutch and damper according to claim 9, wherein the second series of dampers further include a third series of dampers, the third series of dampers configured to compress subsequent to the second series of dampers compressing a predetermined distance.

11. The friction clutch and damper according to claim 8, further comprising a cover plate.

12. The friction clutch and damper according to claim 11, wherein the piston assembly further includes a first side adapted for rotatable engagement with the cover plate.

13. The friction clutch and damper according to claim 12, wherein one of the cover plate and first side of the piston assembly has a friction material disposed thereon.

14. The friction clutch and damper according to claim 13, wherein the other of the cover plate and first side of the piston assembly is heat treated.

15. The friction clutch and damper according to claim 8, wherein the pockets further include a stop configured to engage the tabs of the turbine thereby limiting rotation of the turbine to a predetermined distance.

16. The friction clutch and damper wherein the circumferential wall of the piston assembly is substantially perpendicular to the inboard surface of the piston assembly such that the first and second series of springs are configured for slideable engagement therewith.
